(19) United States
(12) Patent Application Publication
(10) Pub. No.: US 2017/0090316 A1
(43) Pub. Date: Mar. 30, 2017

(54) ELECTROSTATIC CHARGE IMAGE DEVELOPING TONER, ELECTROSTATIC CHARGE IMAGE DEVELOPER, AND TONER CARTRIDGE

(71) Applicant: FUJI XEROX CO., LTD., Tokyo (JP)

(72) Inventors: Shinichi YAOI, Kanagawa (JP); Yasushige NAKAMURA, Kanagawa (JP); Seijiro ISHIMARU, Kanagawa (JP)

(73) Assignee: FUJI XEROX CO., LTD., Tokyo (JP)

(21) Appl. No.: 15/007,369

(22) Filed: Jan. 27, 2016

(30) Foreign Application Priority Data
Sep. 24, 2015 (JP) 2015-187418

(51) Int. Cl. G03G 9/087; G03G 9/08; G03G 15/08

(52) U.S. Cl. CPC G03G 9/08755; G03G 15/0865; G03G 9/0819

(57) ABSTRACT

An electrostatic charge image developing toner includes toner particles including a polyester resin that is a polycondensate of a polycarboxylic acid and a polyol not containing a derivative of bisphenol A, wherein, when a maximum value is present on a lowest molecular weight side in a molecular weight distribution curve obtained by subjecting a component soluble in tetrahydrofuran of the toner particles to a gel permeation chromatography measurement, a weight average molecular weight (Mw (A)) and a number average molecular weight thereof (Mn (A)), each with respect to a low molecular weight region (A) including the maximum value on the lowest molecular weight side, satisfy that a ratio Mw (A)/Mn (A) is 6.0 or less, and a small diameter side number average particle diameter distribution index of the toner particles is from 1.3 to 1.7.

### CROSS-REFERENCE TO RELATED APPLICATIONS

This application is based on and claims priority under 35 USC 119 from Japanese Patent Application No. 2015-187418 filed Sep. 24, 2015.

### BACKGROUND

1. Technical Field

The present invention relates to an electrostatic charge image developing toner, an electrostatic charge image developer, and a toner cartridge.

2. Related Art

A method of visualizing image information by forming and developing an electrostatic charge image by electrophotography is currently used in various fields. In electrophotography, image information is visualized as an image through the following processes: a charging and exposure process in which image information is formed as an electrostatic charge image on a surface of a image holding member (photoreceptor) and developing a toner image on the surface of the photoreceptor by using a developer containing a toner; a transfer process in which the toner image is transferred onto a recording medium such as paper; and a fixing process in which the toner image is fixed onto the surface of the recording medium.

### SUMMARY

According to an aspect of the invention, there is provided an electrostatic charge image developing toner including:

toner particles including a polyester resin that is a polycondensate of a polycarboxylic acid and a polyol not containing a derivative of bisphenol A,

wherein, when a maximum value is present on a lowest molecular weight side in a molecular weight distribution curve obtained by subjecting a component soluble in tetrahydrofuran in the toner particles to a gel permeation chromatography measurement, a weight average molecular weight (Mw (A)) and a number average molecular weight thereof (Mn (A)), each with respect to a low molecular weight region (A) including the maximum value on the lowest molecular weight side, satisfy that a ratio Mw (A)/Mn (A) is 6.0 or less, and

a small diameter side number average particle diameter distribution index of the toner particles is from 1.3 to 1.7.

### BRIEF DESCRIPTION OF THE DRAWINGS

Exemplary embodiments of the present invention will be described in detail based on the following figures, wherein:

FIG. 1 is a diagram illustrating a screw state of an example of a screw extruder that is used in preparation of a toner according to an exemplary embodiment;

FIG. 2 is a schematic diagram showing the configuration of an example of an image forming apparatus according to an exemplary embodiment;

FIG. 3 is a schematic diagram showing the configuration of an example of a process cartridge according to an exemplary embodiment; and

FIGS. 4A and 4B are graphs illustrating a low molecular weight region of the toner according to an exemplary embodiment as provided by GPC measurement.

### DETAILED DESCRIPTION

Hereinafter, exemplary embodiments as examples of the present invention will be described in detail.

Electrostatic Charge Image Developing Toner

An electrostatic charge image developing toner (hereinafter, referred to as “toner”) according to an exemplary embodiment has toner particles containing a polyester resin which is a polycondensate of a polycarboxylic acid and a polyol not including a derivative of bisphenol A.

When a maximum value (hereinafter, the maximum value is also referred to as “peak”) is present on a lowest molecular weight side in a molecular weight distribution curve obtained by gel permeation chromatography measurement to a component soluble in tetrahydrofuran (hereinafter, also referred to as “THF soluble component”) in the toner particles obtained by gel permeation chromatography measurement (hereinafter, also referred to as “GPC measurement”), a weight average molecular weight (Mw (A)) and a number average molecular weight (Mn (A)), each with respect to the low molecular weight region (A) including the maximum value on the lowest molecular weight side, satisfy that a ratio Mw (A)/Mn (A) is 6.0 or less.

Furthermore, a small diameter side number average particle diameter distribution index of the toner particles is from 1.3 to 1.7.

Since the toner according to the exemplary embodiment has the above configuration, low temperature offset is prevented from occurring even in a low temperature environment. Although the reason is not clear, it is assumed that low temperature offset is prevented for the reason mentioned below.

In recent years, from the viewpoint of reducing a standard power consumption value in consideration of the environment, for example, it has been desired to decrease a fixing temperature and shorten the time from when an image forming start instruction is made to when the rear end of a first recording medium is discharged from the image forming apparatus (first print time) in an image forming apparatus of an electrophotography system. In order to meet this demand, various attempts have been made and for example, as a toner, a toner having toner particles including a polyester resin effective in low temperature fixability has been used.

A toner image that is transferred onto a recording medium is fixed in such a manner that the toner image is melted by bringing the toner image into contact with a fixing member of a fixing device (an example of a fixing unit) and infiltrates into a recording medium (recording paper). When the toner image is fixed to the recording medium, the toner image which is brought into contact with the fixing member is melted and the adhesive force between the toner particles and the recording medium is increased. Thus, the toner image brought into contact with the fixing member is separated from the fixing member.

On the other hand, when the toner image is fixed to the recording medium, in the case in which the melting of the toner image is not sufficient, the adhesive force between the toner image and the recording medium is deteriorated and a part of the toner image is easily transferred to the fixing member. Therefore, a phenomenon that after the fixing member revolves, a part of the toner image transferred to the fixing member is attached to the recording medium to cause an image defect (so-called low temperature offset) easily occurs.

Here, since the fixing member of the fixing device is not heated at the time of an initial stage in which image forming starts in a state in which the image forming apparatus is stopped, the amount of heat to fix the toner image to the recording medium is not easily secured. Therefore, the amount of heat for the fixing member to melt the toner image is easily insufficient and low temperature offset easily occurs.

In addition, low temperature offset easily occurs due to an environmental load in a low temperature environment (for example, at a temperature of 10° C.). In the image forming apparatus during image formation, while the temperature is raised, the humidity is decreased. Thus, the amount of heat of the fixing member is not easily lost by the moisture in the image forming apparatus.

On the other hand, when image forming is stopped, the temperature in the image forming apparatus is low and thus, in order to raise the humidity, the amount of heat of the fixing member is easily lost by the moisture in the image forming apparatus in an initial stage of image formation. Therefore, it is considered that in the initial stage of image formation, the amount of heat to melt the toner image does not easily become sufficient and low temperature offset easily occurs due to an environmental load.

In contrast, in the toner according to the exemplary embodiment, according to the above-described configuration, when toner particles including a polyester resin not including a derivative of bisphenol A, as a polyol component, are used, a peak is present on the lowest molecular weight side in the molecular weight distribution curve of the toner particles obtained by measuring a THF soluble component of the toner particles by GPC, the molecular weight properties of a low molecular weight region including the peak of the lowest molecular weight side is controlled to meet a specific condition, and a small diameter side number average particle diameter distribution index of the toner particles is set to a specific range, the hygroscopicity of the toner particles is enhanced and the heat transference between the toner particles is enhanced. As a result, the melting properties of the toner particles when the toner particles start to melt are enhanced.

Specifically, the hydrophobicity of a polyester resin not including a derivative of bisphenol A, as a polyol component, easily deteriorates and the hygroscopicity thereof increases compared to a polyester resin including a derivative of bisphenol A. Therefore, the toner particles containing a polyester resin not including a derivative of bisphenol A easily absorb the humidity in the image forming apparatus when the image forming apparatus stops image formation. When the toner particles absorb moisture, the superficial glass transition temperature (Tg) of the toner particles easily decreases and as a result, it is considered that the toner particles easily melt even when the amount of heat of the fixing member is small.

In addition, it is considered that in the molecular weight distribution curve of a THF soluble component of the toner particles obtained by GPC measurement by controlling the low molecular weight region to meet a specific condition (when the weight average molecular weight and the number average molecular weight of the low molecular weight region (A) including the peak of the lowest molecular weight side are Mw (A) and Mn (A), respectively, a ratio Mw (A)/Mn (A) of the weight average molecular weight Mw (A) to the number average molecular weight Mn (A) is 6.0 or less), sharper (more sensitive) melting properties are easily obtained and when the toner image is fixed to the recording medium, the toner particles more easily melt.

Further, when the small diameter side number average particle diameter distribution index of the toner particles (low GSDp) is set to be in a range from 1.3 to 1.7 which is a wider range compared to the index range of the toner particles of the related art, the amount of fine powder toner particles (of the small diameter side) (for example, a particle diameter of 5 μm or less) increases. Then, as the amount of the fine powder toner particles increases, the amount of the fine powder toner particles embedded in voids formed between adjacent toner particles increases. Therefore, the volume of voids formed between adjacent toner particles decreases and the number of contact points between the toner particles increase, thereby improving heat transference between the toner particles. As a result, it is considered that even when the amount of heat of the fixing member is small, the toner particles easily melt.

From the above, it is assumed that since the toner according to the exemplary embodiment has the above configuration, even in a low temperature environment, low temperature offset is prevented from occurring.

Hereinafter, the toner according to the exemplary embodiment will be described in detail.

The toner according to the exemplary embodiment includes toner particles and external additives if necessary.

Toner Particles

The toner particles include, for example, a binder resin, and a colorant, a release agent, and other additives if necessary.

Binder Resin

As the binder resin, a polyester resin which is a polycondensate of a polycarboxylic acid and a polyol is suitably used.

However, in the exemplary embodiment, the polyester resin does not include a derivative of bisphenol A as a polyol. Since the polyester resin does not include a derivative of bisphenol A, compared to a case of using a derivative of bisphenol A, hygroscopicity is easily enhanced. As a result, even in a low temperature environment, low temperature offset is prevented from occurring.

As long as the polyester resin does not include a derivative of bisphenol A as a polyol, as the polyester resin, a commercially available product may be used or a synthesized product may be used.

Here, in the exemplary embodiment, the term “derivative of bisphenol A” includes both bisphenol A, and a derivative of bisphenol A such as an alkylene oxide adduct of bisphenol A.

Examples of the polycarboxylic acid include aliphatic dicarboxylic acids (such as oxalic acid, malonic acid, maleic acid, fumaric acid, citraconic acid, itaconic acid, glutaconic acid, succinic acid, alkenylsuccinic acid, adipic acid, and sebacic acid), alicyclic dicarboxylic acids (such as cyclohexanedicarboxylic acid), aromatic dicarboxylic acids (such as terephthalic acid, isophthalic acid, phthalic acid, and naphthalenedicarboxylic acid), anhydrides thereof, and lower alkyl esters (for example, having 1 to 5 carbon atoms) thereof. Among these, as the polycarboxylic acid, for example, aromatic dicarboxylic acids are preferable.

As the polycarboxylic acid, a tri- or higher valent carboxylic acid having a crosslinking structure or a branched structure may be used with the dicarboxylic acids. Examples of the tri- or higher valent carboxylic acid include trimellitic acid, pyromellitic acid, anhydrides thereof, and lower alkyl esters (for example, having 1 to 5 carbon atoms) thereof.

As the polycarboxylic acid, aromatic or aliphatic dicarboxylic acids having a sulfonic acid group (such as sodium salt of 2-sulfoterephthalate, and sodium salt of 5-sulfoisophthalate, and sodium salt of sulfosuccinate) may be used in addition to the above acids.

The polycarboxylic acids may be used singly or in combination of two or more kinds thereof.

The polyol is not particularly limited as long as a derivative of bisphenol A is not used. Examples thereof include aliphatic polyols (aliphatic diols such as ethylene glycol, diethylene glycol, triethylene glycol, propylene glycol, butanediol, pentanediol, hexanediol, heptanediol, octanediol, nonanediol, and decanediol; for example, alicyclic diols such as cyclohexanediol, cyclohexane dimethanol, and hydrogenated bisphenol A), and aromatic polyols (for example, aromatic diols such as hydroquinone and benzene dimethanol).

Among these, as the polyol, from the viewpoint of increasing hygroscopicity and further preventing low temperature offset from occurring, for example, aliphatic polyols (aliphatic diols and alicyclic diols) may be used, and a linear aliphatic polyol (a linear aliphatic diol preferably having 2 to 10 carbon atoms and more preferably having 2 to 8 carbon atoms) is preferable.

As the polyol, from the viewpoint of increasing hygroscopicity and further preventing low temperature offset from occurring, an aliphatic polyol (preferably, a linear aliphatic diol (preferably having 2 to 10 carbon atom and more preferably having 2 to 8 carbon atoms)) may be contained in an amount of 40% by weight or more, is preferably from 50% by weight to 100% by weight, and is more preferably from 60% by weight to 100% by weight with respect to the total amount of the polyol.

As the polyol, a tri- or higher valent polyol having a crosslinking structure or a branched structure may be used with diol. Examples of the tri- or higher valent polyol include aliphatic triols such as glycerin and trimethylolpropane; and tetraols such as pentaerythritol.

The polyols may be used singly or in combination of two or more kinds thereof.

In the exemplary embodiment, the polyester resin that is contained in the toner particles and does not have a derivative of bisphenol A as the polyol is analyzed by a nuclear magnetic resonance (NMR) apparatus. Specifically, for example, a sample for measurement of the toner particles as an object to be measured is adopted. Then, the toner particles as a sample for measurement are dissolved in a heavy hydrocarbon solvent and components constituting the toner particles are analyzed by a proton nuclear magnetic resonance (¹H-NMR) apparatus.

In addition, the content of the each component constituting the polyester resin included in the toner particles (for example, a linear aliphatic diol and the like) is calculated by measuring the toner particle as a sample for measurement and an internal standard substance whose concentration is known by a proton nuclear magnetic resonance (¹H-NMR) apparatus and comparing the spectrum of a separately measured component as a target component whose concentration is known (for example, a linear aliphatic diol and the like) with the proton nuclear magnetic resonance (¹H-NMR) spectrum of only the internal standard substance.

The glass transition temperature (Tg) of the polyester resin is preferably from 50° C. to 80° C. and more preferably from 50° C. to 65° C.

The glass transition temperature is obtained from a DSC curve obtained by differential scanning calorimetry (DSC) and more specifically, the glass transition temperature is obtained from “extrapolated glass transition onset temperature” described in the method of obtaining a glass transition temperature in accordance with JIS K-7121-1987 “testing methods for transition temperatures of plastics”.

The weight average molecular weight (Mw) of the polyester resin is preferably from 5,000 to 1,000,000 and more preferably from 7,000 to 500,000.

The number average molecular weight (Mn) of the polyester resin is preferably from 2,000 to 100,000.

The molecular weight distribution Mw/Mn of the polyester resin is preferably from 1.5 to 100 and more preferably from 2 to 60.

The weight average molecular weight and the number average molecular weight are measured by gel permeation chromatography (GPC). The molecular weight measurement by GPC is performed using GPC HLC-8120, Column TSK gel Super HM-M (15 cm), manufactured by Tosoh Corporation, as a measuring apparatus, and a THF solvent. The weight average molecular weight and the number average molecular weight are calculated using a molecular weight calibration curve plotted from a monodisperse polystyrene standard sample from the results of the foregoing measurement.

A known preparing method is used to prepare the polyester resin. Specific examples thereof include a method of conducting a reaction at a polymerization temperature set to from 180° C. to 230° C., if necessary, under reduced pressure in the reaction system, while removing water or an alcohol generated during condensation.

When monomers of the raw materials are not dissolved or compatibilized at a reaction temperature, a high boiling point solvent may be added as a solubilizing agent to dissolve the monomers. In this case, a polycondensation reaction is conducted while distilling the solubilizing agent. When a monomer having poor compatibility is present in a copolymerization reaction, the monomer having poor compatibility and an acid or an alcohol to be polycondensed with the monomer may be condensed and then polycondensed with the main component.

Here, as the polyester resin, modified polyester resin may be used other than the aforementioned unmodified polyester resins. The modified polyester resin is a polyester resin in which a binding group other than an ester bond is present or a resin component, which is different the polyester resin component in constitution, is connected via a covalent bond or an ionic bond. Examples of the modified polyester resin include an epoxy-modified polyester resin modified by using an epoxy compound.

The epoxy-modified polyester resin may be obtained by, for example, incorporating an epoxy compound, a polycarboxylic acid, and a polyol during the polycondensation of the polycarboxylic acid and the polyol. Examples of the epoxy compound include naphthalene type epoxy compounds, phenol novolac type epoxy compounds, and cresol novolac type epoxy compounds.

In a case of using an epoxy compound, the content of the epoxy compound may be in a range from 7% by weight to 12% by weight and is preferably in a range from 8% by weight to 11% by weight with respect to the total amount of the polycondensation component including the epoxy compound.

When the epoxy compound whose content is within the above range is used, not only the occurrence of low temperature offset is further prevented, but also the occurrence of high temperature offset is more likely to be prevented.

For example, the content of the binder resin is preferably from 40% by mass to 95% by mass, more preferably from 50% by mass to 90% by mass, and still more preferably 60% by mass to 85% by mass with respect to the entire toner particles.

As the binder resin, from the viewpoint of further preventing low temperature offset from occurring, the above-described polyester resins are desirably used singly. However, other binder resins may be used with the above-described polyester resins.

Examples of other binder resins include vinyl resins formed of homopolymers of monomers of styrenes (such as styrene, parachlorostyrene, and α-methylstyrene), (meth)acrylic esters (such as methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (such as acrylonitrile and methacrylonitrile), vinyl ethers (such as vinyl methyl ether and vinyl isobutyl ether) vinyl ketones (such as vinyl methyl ketone, vinyl ethyl ketone, and vinyl isopropenyl ketone), and olefins (such as ethylene, propylene, and butadiene), or copolymers obtained by the combination of two or more of these monomers.

Examples of other binder resins also include non-vinyl resins such as epoxy resins, polyurethane resins, polyamide resins, cellulose resins, polyether resins, and modified rosin, mixtures thereof with the above-described vinyl resins, or graft polymers obtained by polymerizing a vinyl monomer with the coexistence of such non-vinyl resins.

These other binder resins may be used singly or in combination of two or more kinds thereof.

Colorant

Examples of the colorant include various pigments such as carbon black, chrome yellow, Hansa yellow, benzidine yellow, thuren yellow, quinoline yellow, pigment yellow, permanent orange GTR, pyrazolone orange, Balkan orange, watch young red, permanent red, brilliant carmin 3B, brilliant carmin 6B, DuPont oil red, pyrazolone red, lithol red, Rhodamine B Lake, Lake Red C, pigment red, rose bengal, aniline blue, ultramarine blue, chalco oil blue, methylene blue chloride, phthalocyanine blue, pigment blue, phthalocyanine green, and malachite green oxalate, and various dyes such as acridine dyes, xanthene dyes, azo dyes, benzoquinone dyes, azine dyes, anthraquinone dyes, thioindigo dyes, dioxadine dyes, thiazine dyes, azomethine dyes, indigo dyes, phthalocyanine dyes, aniline black dyes, polymethine dyes, triphenylmethane dyes, diphenylmethane dyes, and thiazole dyes.

The colorant may be used singly or in combination of two or more kinds thereof.

If necessary, the colorant may be surface-treated or used in combination with a dispersant. Plural kinds of colorants may be used in combination.

The content of the colorant is, for example, preferably from 1% by weight to 30% by weight and more preferably from 3% by weight to 15% by weight with respect to the entire toner particles.

Release Agent

Examples of the release agent include hydrocarbon waxes; natural waxes such as carnauba wax, rice wax, and candelilla wax; synthetic or mineral/petroleum waxes such as montan wax; and ester waxes such as fatty acid esters and montanic acid esters. The release agent is not limited thereto.

The melting temperature of the release agent is preferably from 50° C. to 110° C. and more preferably from 60° C. to 100° C.

The melting temperature is obtained from the “melting peak temperature” described in the method of obtaining a melting temperature in the “testing methods for transition temperatures of plastics” in JIS K-7121-1987, from a DSC curve obtained by differential scanning calorimetry (DSC).

The content of the release agent is, for example, preferably from 1% by weight to 20% by weight and more preferably from 5% by weight to 15% by weight with respect to the entire toner particles.

Other Additives

Examples of other additives include known additives such as a magnetic material, a charge controlling agent, and an inorganic powder. The toner particles include these additives as internal additives.

Characteristics of Toner Particles and the Like

The toner particles may be toner particles having a single layer structure, or toner particles having a so-called core-shell structure composed of a core (core particle) and a coating layer (shell layer) coated on the core.

Here, toner particles having a core/shell structure may be composed of, for example, a core containing a binder resin, and if necessary, other additives such as a colorant and a release agent and a coating layer containing a binder resin.

In the exemplary embodiment, from the viewpoint of further preventing low temperature offset from occurring, when the weight average molecular weight of the low molecular weight region (A) having the peak on the lowest molecular weight side in the molecular weight distribution curve of the THF soluble component of the toner particles obtained by GPC measurement, and including the peak is Mw (A), and the number average molecular weight is Mn (A), the ratio Mw (A)/Mn (A) of the weight average molecular weight Mw (A) to the number average molecular weight Mn (A) is 6.0 or less.

The lower limit of the ratio Mw (A)/Mn (A) may be 1 or more. In addition, from the viewpoint of preventing low temperature offset from occurring, the ratio Mw (A)/Mn (A) is preferably from 2 to 5.6 and more preferably from 2 to 5.

In the exemplary embodiment, the term “molecular weight distribution curve” refers to a fine powder molecular weight distribution curve.

The ratio Mw (A)/Mn (A) of the weight average molecular weight Mw (A) to the number average molecular weight Mn (A) is controlled by, for example, a method of mixing polyester resins having different molecular weights when the toner particles are prepared, and a method of adjusting the conditions for preparing toner particles (for example, conditions according to a kneading and pulverizing method).

The weight average molecular weight Mw (A) of the low molecular weight region (A) may be in a range from 14,000 to 23,000 and is preferably in a range from 14,000 to 20,000.

In addition, the number average molecular weight Mn (A) of the low molecular weight region (A) may be in a range from 4,000 to 7,000 and is preferably in a range from 4,600 to 7,000.

The weight average molecular weight Mw of the THF soluble component of the toner particles obtained by GPC measurement (that is, the weight average molecular weight Mw including the low molecular weight region (A) and a high molecular weight region (B)) may be from 16,000 to 25,000 and is preferably from 17,000 to 21,000. Further, the number average molecular weight Mn (that is, the number average molecular weight Mn including the low molecular weight region (A) and a high molecular weight region (B)) may be from 4,500 to 5,100 and is preferably from 4,900 to 5,000.

Further, from the viewpoint of further preventing low temperature offset from occurring, in the molecular weight distribution curve of the THF soluble component of the toner particles obtained by GPC measurement, the peak of the lowest molecular weight side may be present in a molecular weight range from 6,000 to 12,000 and is preferably present in a molecular weight range from 8,000 to 11,000.

In the exemplary embodiment, from the viewpoint of preventing low temperature offset from occurring, the toner particles have a peak or a gently sloping curve portion (a so-called shoulder) in a region closer to the high molecular weight side than the low molecular weight region (A) including the peak of the lowest molecular weight side in the molecular weight distribution curve of the THF soluble component of the toner particles obtained by GPC measurement. The number of peaks or the number of gently sloping curve portions in the region closer to the high molecular weight side than the low molecular weight region (A) is not particularly limited. For example, the number of peaks or the number of gently sloping curve portions may be from 1 to 3.

In the exemplary embodiment, the term “maximum value” (peak) refers to a portion having an arch shape drawn by a curve fluctuating in a vertical direction in the molecular weight distribution curve obtained by GPC measurement. The term “gently sloping curve portion (shoulder)” refers to a portion in which a curve fluctuating in the vertical direction is not drawn and is not visually recognized as a well-defined peak in the molecular weight distribution curve.

In addition, the term “maximum value of the lowest molecular weight side” (the peak of the lowest molecular weight side) refers to a peak which first appears on a low molecular weight side (that is, a peak which appears on the lowest molecular weight side) in the molecular weight distribution curve of the THF soluble component obtained by GPC measurement.

In the exemplary embodiment, the low molecular weight region (A) including the low molecular weight side and the high molecular weight region (B) closer to a high molecular weight side than the low molecular weight region (A) refer to regions shown below.

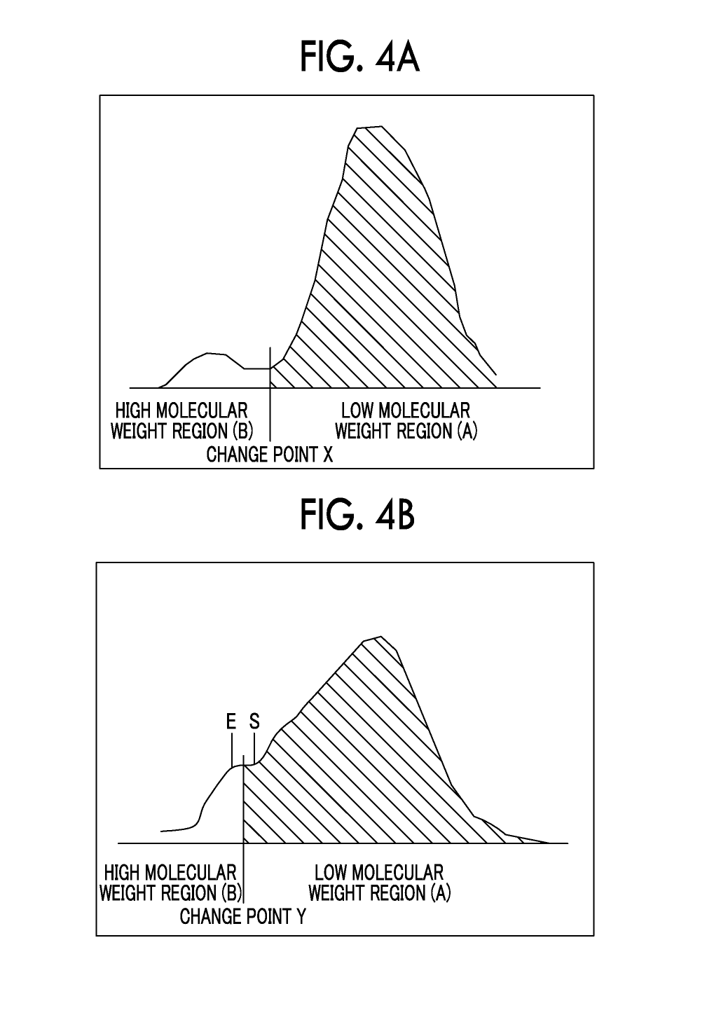

For example, as shown in FIG. 4A, in the molecular weight distribution curve of the THF soluble component obtained by GPC measurement, when the molecular weight distribution curve has two peaks, a position which has the first minimum value on the high molecular weight side from the peaks appearing on the lowest molecular weight side in a direction from the low molecular weight side to the high molecular weight side, is set to a change point X. Then, a region on the low molecular weight side from the change point X is set to a low molecular weight region (A). In addition, a region on the high molecular weight side from the change point X is set to a high molecular weight region (B).

On the other hand, as shown in FIG. 4B, when a peak is present on the lowest molecular weight side in the molecular weight distribution curve of the THF soluble component obtained by GPC measurement, and the first gently sloping curve portion (shoulder) closer to the high molecular weight side than the peak appearing on the lowest molecular weight side in a direction from the low molecular weight side to the high molecular weight side appears, an intermediate point between the start point S which becomes the gently sloping curve portion and the end point E in which the gently sloping curve portion ends is set to a change point Y. A region on the low molecular weight side from the change point Y is set to a low molecular weight region (A). In addition, a region on the high molecular weight side from the change point Y is set to a high molecular weight region (B).

Although not shown, in the molecular weight distribution curve of the THF soluble component obtained by GPC measurement, when plural peaks, or plural gently sloping curve portions appear or peaks and gently sloping curve portions appear in combination on the high molecular weight side from the peak appearing on the lowest molecular weight side, a change point of a peak or a gently sloping curve portion which first appears on the high molecular weight side from the peak appearing on the lowest molecular weight side, in a direction from the low molecular weight side to the high molecular weight side, is obtained according to the same procedure as obtaining the change point X or the change point Y and a region on the low molecular weight side from the obtained change point is set to a low molecular weight region (A).

Here, in the “gently-sloping curve portion (shoulder)” that is not a visually recognizable well-defined peak in the exemplary embodiment, the peak may be separated in a state shown below.

For the gently-sloping curve portion (shoulder), first, a moving average differential molecular weight value is obtained by taking a moving averaging of differential molecular weight values at every molecular weight of 10. Next, in the obtained moving average differential molecular weight value, a slope a of the logarithm of the molecular weight is obtained at every molecular weight of 10 as in obtaining the moving average.

In the curve portion slanting downward from the peak of the low molecular weight side to the high molecular weight side, the aforementioned slope a is “<0, a negative value”, when the curve is a gently sloping curve, the aforementioned slope a approaches “0” and if the moving average differential molecular weight value becomes larger than the above value, the slope a is “>0, a positive value”. Here, a portion in which the slope a is 0 for the first time is set to a start point S and a portion in which the slope is 0 next time is set to an end point E.

For the molecular weight distribution curve of the THF soluble component of the toner particles (toner) obtained by GPC measurement, and each average molecular weight is obtained by dissolving 0.5 mg of toner particles as an object to be measured in 1 g of tetrahydrofuran (THF), subjecting the solution to ultrasonic dispersion, then adjusting the concentration of the toner particles to 0.5% by weight, and measuring the dissolved component by GPC.

The measurement is carried out using “HLC-8120GPC, SC-8020 equipment (manufactured by Tosoh Corporation)” as a GPC apparatus, two columns “TSK gel, Super HM-H (6.0 mm ID×15 cm, manufactured by Tosoh Corporation)”, and THF as an eluent. An experiment is performed using an refractive index (IR) detector under the experimental conditions of a sample density of 0.5%, a flow rate of 0.6 ml/min, a sample injection amount of 10 μl, and a measurement temperature of 40° C. Further, the calibration curve is made from 10 samples of “polystylene standard sample TSK standard” manufactured by Tosoh Corporation: “A-500”, “F-1”, “F-10”, “F-80”, “F-380”, “A-2500”, “F-4”, “F-40”, “F-128”, and “F-700”.

The small diameter side number average particle diameter distribution index (low GSDp) of the toner particles is from 1.3 to 1.7. From the viewpoint of further preventing low temperature offset from occurring, the small diameter side number average particle diameter distribution index is preferably from 1.3 to 1.6 and more preferably from 1.35 to 1.5. When the small diameter side number average particle diameter distribution index (low GSDp) is in the above range, the number of small diameter toner particles increases, heat exchange properties between the toner particles are improved and thus low temperature offset is prevented from occurring.

The volume average particle diameter (D50v) of the toner particles is preferably from 5 μm to 14 μm, and more preferably from 6 μm to 12 μm from the viewpoint of further preventing low temperature offset from occurring.

Various average particle diameters, such as a volume average particle diameter, and various particle size distribution indices, such as a small diameter side number average particle diameter distribution index, of the toner particles are measured using a Coulter Multisizer II (manufactured by Beckman Coulter, Inc.) and ISOTON-II (manufactured by Beckman Coulter, Inc.) as an electrolyte.

In the measurement, 0.5 mg to 50 mg of a measurement sample is added to 2 ml of a 5% aqueous solution of surfactant (preferably sodium alkylbenzene sulfonate) as a dispersant. The obtained material is added to 100 ml to 150 ml of the electrolyte.

The electrolyte in which the sample is suspended is subjected to a dispersion treatment using an ultrasonic disperser for 1 minute, and a particle size distribution of particles having a particle diameter in a range from 2 μm to 60 μm is measured by a Coulter Multisizer II using an aperture having an aperture diameter of 100 μm. 50,000 particles are sampled.

Cumulative distributions by volume and by number are respectively drawn from the side of the small diameter with respect to particle size ranges (channels) separated based on the measured particle size distribution. The particle diameter when the cumulative percentage becomes 16% is defined as a volume particle diameter D16v and a number particle diameter D16p, while the particle diameter when the cumulative percentage becomes 50% is defined as a volume average particle diameter D50v and a cumulative number average particle diameter D50p. Furthermore, the particle diameter when the cumulative percentage becomes 84% is defined as a volume particle diameter D84v and a number particle diameter D84p.

Using these, a volume average particle diameter distribution index (GSDv) is calculated by (D84v/D16v)^{1/2}, and a number average particle diameter distribution index (GSDp) is calculated by (D84p/D16p)^{1/2}.

In addition, the small diameter side number average particle diameter distribution index (low GSDp) is calculated by (D50p/D16p)^{1/2}.

The shape factor SF1 of the toner particles is preferably from 110 to 150 and more preferably from 120 to 140.

The shape factor SF1 is obtained through the following expression.

SF1=(ML²/A)×(π/4)×100 Expression

In the expression, ML represents an absolute maximum length of a toner particle and A represents a projected area of a toner particle, respectively.

Specifically, the shape factor SF1 is numerically converted mainly by analyzing a microscopic image or a scanning electron microscopic (SEM) image by using an image analyzer, and is calculated as follows. That is, an optical microscopic image of particles scattered on the surface of a glass slide is input to an image analyzer Luzex through a video camera to obtain maximum lengths and projected areas of 100 particles, values of SF1 are calculated by the expression, and an average value thereof is obtained.

In the toner particles, the tetrahydrofuran (THF) insoluble component (hereinafter, also referred to as “THF insoluble component”) is preferably from 3% by weight to 10% by weight and more preferably from 3% by weight to 7% by weight with respect to the toner particles.

When a toner image is fixed onto a recording medium (recording sheet), in the case of excessive melting of the toner, a phenomenon that a part of the toner image fixed to the recording medium is peeled off and transferred to the fixing member (so-called high temperature offset) occurs. When the THF insoluble component is in the above range, not only the low temperature offset but also high temperature offset may be easily prevented and thus this case is suitable.

In the exemplary embodiment, the THF insoluble component mainly includes a resin component-derived constituent component among THF insoluble constituent components of the toner particles. When the toner particles include a release agent, the THF insoluble component includes THF insoluble components excluding an inorganic material and a release agent. That is, the THF insoluble component is an insoluble component including a THF insoluble binder resin component as a main component (for example, 90% by weight or more with respect to the total amount).

The THF insoluble component is measured by the following manner.

Toner particles as an object to be measured is put into a conical flask, THF is put into the flask and the flask is sealed. The mixture is allowed to stand for 24 hours. Then, the mixture is moved to a centrifugation glass tube and THF is put into the conical flask again to wash the flask. The THF is moved to the centrifugation glass tube and the flask is sealed. Then, centrifugation is performed for 30 minutes under conditions of a rotation number of 20,000 rpm and a temperature of −10° C. After the centrifugation, the contents are taken out and allowed to stand and then a supernatant is removed to calculate the THF insoluble component of the entire toner particles.

The ratio of the resin component in the insoluble component is calculated by a thermogravimetric apparatus (TGA). In the measurement, a release agent is volatilized at the initial stage by raising the temperature to 600° C. in a nitrogen stream at a temperature rising rate of 20° C./minute, and then a resin component-derived sold component is thermally decomposed. A remaining colorant (pigment)-derived component is thermally decomposed in the air by continuously raising the temperature by changing the conditions and the remaining ash content becomes an inorganic component-derived solid component. The ratio of the resin component-derived insoluble component in the insoluble component is calculated from the ratio of these components. In this manner, the amount of the resin component of the toner particles is calculated and the ratio of the THF insoluble component in total amount of the resin component is calculated from the ratio between the amount of the resin component in the THF insoluble component and the resin component in the toner particles.

External Additive

Examples of the external additive include SiO₂, TiO₂, Al₂O₃, CuO, ZnO, SnO₂, CeO₂, Fe₂O₃, MgO, BaO, CaO, K₂O, Na₂O, ZrO₂, CaO.SiO₂, K₂O.(TiO₂)n, Al₂O₃.2SiO₂, CaCO₃, MgCO₃, BaSO₄, and MgSO₄.

Surfaces of the inorganic particles as an external additive may be subjected to a hydrophobizing treatment. The hydrophobizing treatment is performed by, for example, dipping the inorganic particles in a hydrophobizing agent. The hydrophobizing agent is not particularly limited and examples thereof include a silane coupling agent, silicone oil, a titanate coupling agent, and an aluminum coupling agent. These may be used singly or in combination of two or more kinds thereof.

Generally, the amount of the hydrophobizing agent is, for example, from 1 part by weight to 10 parts by weight with respect to 100 parts by weight of the inorganic particles.

Examples of the external additive also include resin particles (resin particles such as polystyrene, polymethyl methacrylate (PMMA), and melamine resin particles) and a cleaning aid (for example, metal salt of higher fatty acid represented by zinc stearate, and fluorine polymer particles).

The amount of the external additive externally added is, for example, preferably from 0.01% by weight to 5% by weight, and more preferably from 0.01% by weight to 3.0% by weight with respect to the toner particles.

Toner Preparing Method

Next, a method of preparing a toner according to the exemplary embodiment will be described.

The toner according to the exemplary embodiment is obtained by externally adding an external additive to toner particles after preparing of the toner particles.

The toner particles may be prepared using any of a dry process (for example, a kneading and pulverizing method) and a wet process (for example, an aggregation and coalescence method, a suspension and polymerization method, and a dissolution and suspension method). The toner particle preparing method is not particularly limited to these processes, and a known process is employed.

Specifically, for example, when the toner particles are prepared by an aggregation and coalescence method, the toner particles are prepared through the processes of: preparing a resin particle dispersion in which resin particles as a binder resin are dispersed (resin particle dispersion preparation process); aggregating the resin particles (if necessary, other particles) in the resin particle dispersion (if necessary, in the dispersion after mixing with other particle dispersions) to form aggregated particles (aggregated particle forming process); and heating the aggregated particle dispersion in which the aggregated particles are dispersed, to coalesce the aggregated particles, thereby forming toner particles (coalescence process).

Hereinafter, the respective processes will be described in detail.

In the following description, a method of obtaining a toner particles including a colorant and a release agent will be described. However, the colorant and the release agent are used if necessary. Additives other than the colorant and the release agent may be used.

Resin Particle Dispersion Preparation Process

First, for example, a colorant particle dispersion in which colorant particles are dispersed and a release agent particle dispersion in which release agent particles are dispersed are prepared together with a resin particle dispersion in which resin particles as a binder resin are dispersed.

Here, the resin particle dispersion is prepared by, for example, dispersing resin particles by a surfactant in a dispersion medium.

Examples of the dispersion medium used for the resin particle dispersion include aqueous mediums.

Examples of the aqueous mediums include water such as distilled water and ion exchange water, and alcohols. These may be used singly or in combination of two or more kinds thereof.

Examples of the surfactant include anionic surfactants such as sulfuric ester salt, sulfonate, phosphate, and soap anionic surfactants; cationic surfactants such as amine salt and quaternary ammonium salt cationic surfactants; and nonionic surfactants such as polyethylene glycol, ethylene oxide adduct of alkyl phenol, and polyol nonionic surfactants. Among these, particularly, anionic surfactants and cationic surfactants are used. Nonionic surfactants may be used in combination with anionic surfactants or cationic surfactants.

The surfactants may be used singly or in combination of two or more kinds thereof.

Regarding the resin particle dispersion, as a method of dispersing the resin particles in the dispersion medium, a common dispersing method using, for example, a rotary shearing-type homogenizer, or a ball mill, a sand mill, or a Dyno mill having media is exemplified. Depending on the kind of the resin particles, resin particles may be dispersed in the resin particle dispersion using, for example, a phase inversion emulsification method.

The phase inversion emulsification method includes: dissolving a resin to be dispersed in a hydrophobic organic solvent in which the resin is soluble; conducting neutralization by adding abase to an organic continuous phase (O phase); and converting the resin (so-called phase inversion) from W/O to O/W by putting an aqueous medium (W phase) to form a discontinuous phase, thereby dispersing the resin as particles in the aqueous medium.

The volume average particle diameter of the resin particles dispersed in the resin particle dispersion is, for example, preferably from 0.01 μm to 1 μm, more preferably from 0.08 μm to 0.8 μm, and even more preferably from 0.1 μm to 0.6 μm.

Regarding the volume average particle diameter of the resin particles, a cumulative distribution by volume is drawn from the side of the small diameter with respect to particle size ranges (channels) separated using the particle size distribution obtained by the measurement of a laser diffraction-type particle size distribution measuring device (for example, LA-700, manufactured by Horiba, Ltd.), and a particle diameter when the cumulative percentage becomes 50% with respect to the entire particles is measured as a volume average particle diameter D50v. The volume average particle diameter of the particles in other dispersions is also measured in the same manner.

The content of the resin particles contained in the resin particle dispersion is, for example, preferably from 5% by weight to 50% by weight, and more preferably from 10% by weight to 40% by weight.

For example, the colorant particle dispersion and the release agent particle dispersion are also prepared in the same manner as in the case of the resin particle dispersion. That is, the particles in the resin particle dispersion are the same as the colorant particles dispersed in the colorant particle dispersion and the release agent particles dispersed in the release agent particle dispersion, in terms of the volume average particle diameter, the dispersion medium, the dispersing method, and the content of the particles.

Aggregated Particle Forming Process

Next, the colorant particle dispersion and the release agent dispersion are mixed together with the resin particle dispersion.

Then, the resin particles, the colorant particles, and the release agent particles are heterogeneously aggregated in the mixed dispersion, thereby forming aggregated particles having a diameter close to a target toner particle diameter and including the resin particles, the colorant particles, and the release agent particles.

Specifically, for example, an aggregating agent is added to the mixed dispersion and a pH of the mixed dispersion is adjusted to acidic (for example, the pH is from 2 to 5). If necessary, a dispersion stabilizer is added. Then, the mixed dispersion is heated at the glass transition temperature of the resin particles (specifically, for example, from a temperature 30° C. lower than the glass transition temperature of the resin particles to a temperature 10° C. lower than the glass transition temperature) to aggregate the particles dispersed in the mixed dispersion, thereby forming the aggregated particles.

In the aggregated particle forming process, for example, the aggregating agent may be added at room temperature (for example, 25° C.) under stirring of the mixed dispersion using a rotary shearing-type homogenizer, the pH of the mixed dispersion may be adjusted to acidic (for example, the pH is from 2 to 5), a dispersion stabilizer may be added if necessary, and the heating may be then performed.

Examples of the aggregating agent include a surfactant having an opposite polarity to the polarity of the surfactant used as the dispersant to be added to the mixed dispersion, such as inorganic metal salts and di- or higher valent metal complexes. Particularly, when a metal complex is used as the aggregating agent, the amount of the surfactant used is reduced and charging characteristics are improved.

If necessary, an additive may be used to forma complex or a similar bond with the metal ions of the aggregating agent. A chelating agent is preferably used as the additive.

Examples of the inorganic metal salts include metal salts such as calcium chloride, calcium nitrate, barium chloride, magnesium chloride, zinc chloride, aluminum chloride, or aluminum sulfate, and inorganic metal salt polymers such as polyaluminum chloride, polyhydroxy aluminum, or calcium polysulfide.

A water-soluble chelating agent may be used as the chelating agent. Examples of the chelating agent include oxycarboxylic acids such as tartaric acid, citric acid, and gluconic acid, iminodiacetic acid (IDA), nitrilotriacetic acid (NTA), and ethylenediaminetetraacetic acid (EDTA).

The amount of the chelating agent added is, for example, preferably from 0.01 parts by weight to 5.0 parts by weight, and more preferably from 0.1 parts by weight to less than 3.0 parts by weight with respect to 100 parts by weight of the resin particles.

Coalescence Process

Next, the aggregated particle dispersion in which the aggregated particles are dispersed is heated at, for example, a temperature that is equal to or higher than the glass transition temperature of the resin particles (for example, a temperature that is higher than the glass transition temperature of the resin particles by 10° C. to 30° C.) to coalesce the aggregated particles and form toner particles.

Toner Particles are Obtained Through the Foregoing Processes.

After the aggregated particle dispersion in which the aggregated particles are dispersed is obtained, toner particles may be prepared through the processes of: further mixing the resin particle dispersion in which the resin particles are dispersed with the aggregated particle dispersion to conduct aggregation so that the resin particles further adhere to the surfaces of the aggregated particles, thereby forming second aggregated particles; and coalescing the second aggregated particles by heating the second aggregated particle dispersion in which the second aggregated particles are dispersed, thereby forming toner particles having a core-shell structure.

Here, after the coalescence process ends, the toner particles formed in the solution are subjected to known washing process, solid-liquid separation process, and drying process, and thus dry toner particles are obtained.

In the washing process, displacement washing using ion exchange water may be sufficiently performed from the viewpoint of charging properties. In addition, the solid-liquid separation process is not particularly limited, but from the viewpoint of productivity, suction filtration, pressure filtration, and the like may be performed. The method for the drying process is also not particularly limited, but from the viewpoint of productivity, freeze drying, flash jet drying, fluidized drying, vibration type fluidized drying, and the like may be performed.

The toner is prepared by, for example, adding and mixing an external additive with the obtained dry toner particles. The mixing may be performed with, for example, a V-blender, a Henschel mixer, a Lodige mixer, and the like. Furthermore, if necessary, coarse toner particles may be removed using a vibration sieving machine, a wind classifier, and the like.

The kneading and pulverizing method is a method including mixing the respective materials of the binder resin and the like, then melting and kneading the above materials using a heating kneader, a kneader, an extruder, or the like, coarsely pulverizing the obtained melted and kneaded material and then pulverized the material with a jet mill or the like, and obtaining toner particles having a target particle diameter with an air classifier.

More specifically, the kneading and pulverizing method is divided into a kneading process of kneading a toner forming material including a binder resin, and a pulverizing process of pulverizing the kneaded material. If necessary, the method may further include a cooling process of cooling the kneaded material formed by the kneading process and other processes.

Each process according to the kneading and pulverizing method will be described in detail.

Kneading Process

In the kneading process, a toner forming material including a binder resin is kneaded.

In the kneading process, 0.5 parts by weight to 5 parts by weight of an aqueous medium (for example, water such as distilled water or ionized water and alcohols) with respect to 100 parts by weight of the toner forming material is desirably added.

Examples of a kneader used in the kneading process include a mono-axial extruder and a biaxial extruder. A kneader including a feed screw portion and two kneading portion will be described below as an example of the kneader with reference to the accompanying drawing, but the kneader is not limited to this example.

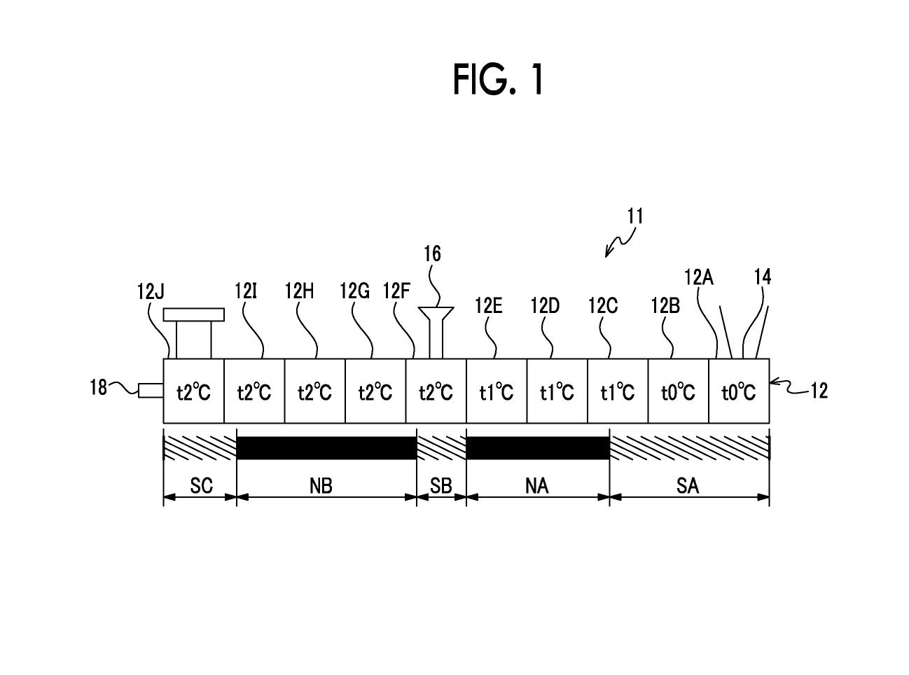

FIG. 1 is a diagram illustrating a screw state in an example of a screw extruder used in the kneading process of the method of preparing a toner according to the exemplary embodiment.

A screw extruder 11 includes a barrel 12 that includes a screw (not shown), an injection port 14 that is used to inject the toner forming material as a raw material for the toner into the barrel 12, a liquid adding port 16 that is used to add an aqueous medium to the toner forming material in the barrel 12, and a discharge port 18 that is used to discharge a kneaded material formed by kneading the toner forming material from the barrel 12.

The barrel 12 is divided into, sequentially from the closest to the injection port 14, a feed screw portion SA feeding the toner forming material injected from the injection port 14 to a kneading portion NA, a kneading portion NA melting and kneading the toner forming material through a first kneading process, a feed screw portion SB feeding the toner forming material melted and kneaded in the kneading portion NA to a kneading portion NB, a kneading portion NB melting and kneading the toner forming material through a second kneading process to form a kneaded material, and a feed screw portion SC feeding the formed kneaded material to the discharge portion 18.

Temperature controllers (not shown) different depending on blocks are provided in the barrel 12. That is, blocks 12A to 12J may be controlled at different temperatures. In FIG. 1, the temperatures of blocks 12A and 12B are controlled into t0° C., the temperatures of blocks 12C to 12E are controlled into t1° C., and the temperatures of blocks 12F to 12J are controlled to t2° C., respectively. Accordingly, the toner forming material in the kneading part NA is heated to t1° C. and the toner forming material in the kneading part NB is heated to t2° C.

When the toner-forming material including a binder resin, a colorant, and a release agent, if necessary, is supplied to the barrel 12 from the injection port 14, the toner forming material is transported to the kneading portion NA by the feed screw portion SA. At this time, since the temperature of the block 12C is set to t1° C., the toner forming material is transported to the kneading portion NA in a state in which the toner forming material is heated and melted. Since the temperatures of the block 12D and block 12E are set to t1° C., the toner forming material in the kneading portion NA is melted and kneaded at the temperature of t1° C. The binder resin and the release agent are melted in the kneading portion NA and are sheared by the screw.

Next, the toner forming material having been subjected to the kneading in the kneading portion NA is sent to the kneading portion NB by the feed screw portion SB.

In the feed screw portion SB, an aqueous medium is added to the toner forming material by injecting the aqueous medium into the barrel 12 from the liquid adding port 16. FIG. 1 shows a state in which the aqueous medium is injected into the feed screw portion SB, but the injection position is not limited to this example. The aqueous medium may be injected into the kneading portion NB or the aqueous medium may be injected into both the feed screw portion SB and the kneading portion NB. That is, the positions and the number of injection positions at which the aqueous medium is injected are selected if necessary.

As described above, by injecting the aqueous medium into the barrel 12 from the liquid adding port 16, the toner forming material and the aqueous medium are mixed in the barrel 12, the toner forming material is cooled by latent heat of vaporization of the aqueous medium and thus the toner forming material is maintained at an appropriate temperature.

Finally, the kneaded material formed by melting and kneading the toner-forming material by the kneading portion NB is transported to the discharge port 18 by the feed screw portion SC and is discharged from the discharge port 18.

In this manner, the kneading process using the screw extruder 11 shown in FIG. 1 is performed.

Cooling Process

The cooling process is a process of cooling the kneaded material formed in the kneading process. In the cooling process, it is desirable that the kneaded material is cooled from the temperature of the kneaded material when the kneading process ends to 40° C. or lower at an average temperature falling rate of 4° C./sec or higher. When the cooling rate of the kneaded material is low, mixtures (mixtures of the colorant and internal additives such as the release agent internally added to the toner particles if necessary) finely dispersed in the binder resin in the kneading process may be re-crystallized and the dispersion diameter may increase. On the other hand, when the kneaded material is rapidly cooled at the above average temperature falling rate, the dispersed state immediately after the kneading process ends is maintained without any change, which is preferable. The average temperature falling rate means the average value of rates at which the temperature (t2° C., for example, when the screw extruder 11 shown in FIG. 1 is used) of the kneaded material when the kneading process ends falls to 40° C.

A specific example of the cooling method in the cooling process includes a method using a rolling roll and an insertion type cooling belt in which cool water or brine is circulated. When cooling is performed using the above method, the cooling rate is determined depending on the speed of the rolling roll, the flow rate of brine, the amount of kneaded material supplied, the thickness of a slab during rolling the kneaded material, and the like. The thickness of the slab is preferably in the range of from 1 mm to 3 mm.

Pulverizing Process

The kneaded material cooled by the cooling process is pulverized in the pulverizing process to form particles. In the pulverizing process, for example, a mechanical pulverizer, a jet mill type pulverizer, or the like is used. The pulverized material may be subjected to spheroidizing by heat or mechanical impact.

Classification Process

If necessary, the particles obtained by the pulverizing process may be classified by the classification process to obtain toner particles having a volume average particle diameter in a target range. In the classification process, a centrifugal classifier, an inertial classifier, or the like used in the related art is used to remove fine powder (particles having a diameter smaller than a target range) and coarse powder (particles having a diameter larger than a target range).

In the exemplary embodiment, when a test using the toner prepared by the kneading and pulverizing method is performed, pulverizing may be performed using an IDS-2 collision plate type pulverizer (manufactured by Nippon Pneumatic Mfg. Co., Ltd.) and classification may be performed using an Elbow-jet classifier (manufactured by Matsubo Corporation). Here, it is found that in the pulverizing process, when the pulverizing pressure is increased or the amount to be treated is reduced, the particle diameter of the toner particles becomes smaller or finer, and the particle diameter of the toner particles may be adjusted. Subsequently, in the classification process, by changing a classification edge position, the small diameter side number average particle diameter distribution index (low GSDp) may be controlled.

External Addition Process

In order to adjust the charge, impart fluidity, charge exchanging properties, and the like, inorganic powders represented as the aforementioned specific silica, titanium dioxide, and aluminum oxide may be added and attached to the obtained toner particles. These powders may be attached step by step, for example, through the use of a V-shaped blender, a Henschel mixer, a Loedige mixer, or the like.

Sieving Process

After the external addition process, a sieving process may be provided if necessary. In the sieving method, specifically, a gyro shifter, a vibration sieving machine, a wind classifier, or the like may be used. By performing the sieving process, coarse powders of the external additive or the like are removed and thus the occurrence of a stripe on a photoreceptor and the internal contamination of the apparatus are prevented.

In the exemplary embodiment, the method of preparing the toner particles is not particularly limited but the toner particles are preferably prepared by a kneading and pulverizing method from the viewpoint that the particle size distribution is easily widened, and a large volume average particle diameter and a large amount of fine powder are easily obtained.

Electrostatic Charge Image Developer

An electrostatic charge image developer according to this exemplary embodiment includes at least the toner according to this exemplary embodiment.

The electrostatic charge image developer according to the exemplary embodiment may be a single component developer including only the toner according to the exemplary embodiment and may be a two-component developer obtained by mixing the toner and a carrier.

The carriers are not particularly limited and known carriers may be used. Examples of the carriers include resin coated carriers having a resin coating layer on the surface of the core formed of a magnetic powder, magnetic powder dispersion type carriers in which a magnetic powder is dispersed and blended in a matrix resin, and resin impregnation type carriers in which a porous magnetic powder is impregnated with resin.

The magnetic dispersed carriers and resin impregnated carriers may be carriers in which the constituent particles of the carrier are cores and coated with a coating resin.

Examples of the magnetic powder include magnetic metals such as iron, nickel, and cobalt, and magnetic oxides such as ferrite and magnetite.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, a vinyl chloride-vinyl acetate copolymer, a styrene-acrylic acid copolymer, a straight silicone resin configured to include an organosiloxane bond or a modified product thereof, a fluororesin, polyester, polycarbonate, a phenol resin, and an epoxy resin.

The coating resin and the matrix resin may contain other additives such as conductive particles.

Examples of the conductive particles include particles of metals such as gold, silver, and copper, carbon black particles, titanium oxide particles, zinc oxide particles, tin oxide particles, barium sulfate particles, aluminum borate particles, and potassium titanate particles.

Here, a coating method using a coating layer forming solution in which a coating resin, and if necessary, various additives are dissolved in an appropriate solvent is used to coat the surface of a core with the coating resin. The solvent is not particularly limited, and may be selected in consideration of the coating resin to be used, coating suitability, and the like.

Specific examples of the resin coating method include a dipping method of dipping cores in a coating layer forming solution, a spraying method of spraying a coating layer forming solution to surfaces of cores, a fluidized bed method of spraying a coating layer forming solution onto cores in a state in which the cores are allowed to float by flowing air, and a kneader-coater method in which cores of a carrier and a coating layer forming solution are mixed with each other in a kneader-coater and the solvent is removed.

The mixing ratio (mass ratio) between the toner and the carrier in the two-component developer is preferably from 1:100 to 30:100 (toner:carrier), and more preferably from 3:100 to 20:100.

Image Forming Apparatus and Image Forming Method

An image forming apparatus and an image forming method according to this exemplary embodiment will be described.

The image forming apparatus according to this exemplary embodiment is provided with an image holding member, a charging unit that charges a surface of the image holding member, an electrostatic charge image forming unit that forms an electrostatic charge image on a charged surface of the image holding member, a developing unit that accommodates an electrostatic charge image developer and develops the electrostatic charge image formed on the surface of the image holding member with the electrostatic charge image developer to forma toner image, a transfer unit that transfers the toner image formed on the surface of the image holding member onto a surface of a recording medium, and a fixing unit that fixes the toner image transferred onto the surface of the recording medium. As the electrostatic charge image developer, the electrostatic charge image developer according to this exemplary embodiment is applied.

In the image forming apparatus according to this exemplary embodiment, an image forming method (image forming method according to this exemplary embodiment) including the processes of: charging a surface of an image holding member; forming an electrostatic charge image on the charged surface of the image holding member; developing the electrostatic charge image formed on the surface of the image holding member with the electrostatic charge image developer according to this exemplary embodiment to form a toner image; transferring the toner image formed on the surface of the image holding member onto a surface of a recording medium; and fixing the toner image transferred onto the surface of the recording medium is performed.

As the image forming apparatus according to this exemplary embodiment, a known image forming apparatus is applied, such as a direct transfer type apparatus that directly transfers a toner image formed on a surface of an image holding member onto a recording medium; an intermediate transfer type apparatus that primarily transfers a toner image formed on a surface of an image holding member onto a surface of an intermediate transfer member, and secondarily transfers the toner image transferred onto the surface of the intermediate transfer member onto a surface of a recording medium; an apparatus that is provided with a cleaning unit that cleans a surface of an image holding member before charging after transfer of a toner image; or an apparatus that is provided with an erasing unit that irradiates, after transfer of a toner image, a surface of an image holding member with erase light before charging for erasing.

In the case of an intermediate transfer type apparatus, a transfer unit is configured to have, for example, an intermediate transfer member having a surface onto which a toner image is to be transferred, a primary transfer unit that primarily transfers a toner image formed on a surface of an image holding member onto the surface of the intermediate transfer member, and a secondary transfer unit that secondarily transfers the toner image transferred onto the surface of the intermediate transfer member onto a surface of a recording medium.

In the image forming apparatus according to this exemplary embodiment, for example, a part including the developing unit may have a cartridge structure (process cartridge) that is detachable from the image forming apparatus. As the process cartridge, for example, a process cartridge that accommodates the electrostatic charge image developer according to this exemplary embodiment and is provided with a developing unit is suitably used.

Hereinafter, an example of the image forming apparatus according to this exemplary embodiment will be shown. However, the image forming apparatus is not limited thereto. Main portions shown in the drawing will be described, but descriptions of other parts will be omitted.

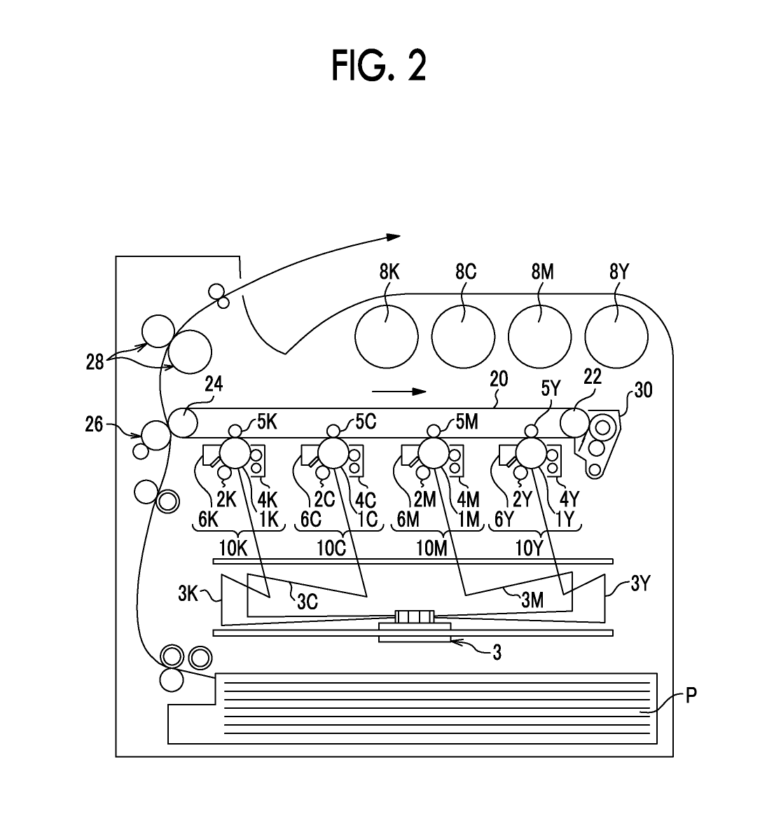

FIG. 2 is a schematic diagram showing the configuration of the image forming apparatus according to this exemplary embodiment.

The image forming apparatus shown in FIG. 2 includes first to fourth electrophotographic image forming units 10Y, 10M, 10C, and 10K (image forming units) that output yellow (Y), magenta (M), cyan (C), and black (K) images based on color separated image data, respectively. These image forming units (hereinafter, simply referred to as “units” in some cases) 10Y, 10M, 100, and 10K are arranged side by side at predetermined intervals in a horizontal direction. These units 10Y, 10M, 100, and 10K may be process cartridges that are detachable from the image forming apparatus.

An intermediate transfer belt 20 as an intermediate transfer member is installed above the units 10Y, 10M, 100, and 10K in the drawing to extend through the units. The intermediate transfer belt 20 is wound around a driving roll 22 and a support roll 24 contacting the inner surface of the intermediate transfer belt 20, which are arranged to be separated from each other on the left and right sides in the drawing, and travels in a direction toward the fourth unit 10K from the first unit 10Y. The support roll 24 is pressed in a direction in which the support roll departs from the driving roll 22 by a spring or the like (not shown), and a tension is given to the intermediate transfer belt 20 wound on both of the rolls. In addition, an intermediate transfer member cleaning device 30 opposed to the driving roll 22 is provided on a surface of the intermediate transfer belt 20 on the image holding member side.

Four color toners, that is, a yellow toner, a magenta toner, a cyan toner, and a black toner accommodated in toner cartridges 8Y, 8M, 8C, and 8K are supplied to developing devices (developing units) 4Y, 4M, 4C, and 4K of the respective units 10Y, 10M, 100, and 10K, respectively.

The first to fourth units 10Y, 10M, 100, and 10K have the same configuration. Here, the first unit 10Y that is disposed on the upstream side in a traveling direction of the intermediate transfer belt to form a yellow image will be representatively described. The same portions as in the first unit 10Y will be denoted by the reference numerals with magenta (M), cyan (C), and black (K) added instead of yellow (Y), and descriptions of the second to fourth units 10M, 100, and 10K will be omitted.

The first unit 10Y has a photoreceptor 1Y acting as an image holding member. Around the photoreceptor 1Y, a charging roll (an example of the charging unit) 2Y that charges a surface of the photoreceptor 1Y to a predetermined potential, an exposure device (an example of the electrostatic charge image forming unit) 3 that exposes the charged surface with laser beams 3Y based on a color-separated image signal to form an electrostatic charge image, a developing device (an example of the developing unit) 4Y that supplies a charged toner to the electrostatic charge image to develop the electrostatic charge image, a primary transfer roll (an example of the primary transfer unit) 5Y that transfers the developed toner image onto the intermediate transfer belt 20, and a photoreceptor cleaning device (an example of the cleaning unit) 6Y that removes the toner remaining on the surface of the photoreceptor 1Y after primary transfer, are arranged in sequence.

The primary transfer roll 5Y is arranged inside the intermediate transfer belt 20 so as to be provided at a position opposed to the photoreceptor 1Y. Furthermore, bias supplies (not shown) that apply a primary transfer bias are connected to the primary transfer rolls 5Y, 5M, 5C, and 5K, respectively. Each bias supply changes a transfer bias that is applied to each primary transfer roll under the control of a controller (not shown).

Hereinafter, an operation of forming a yellow image in the first unit 10Y will be described.

First, before the operation, the surface of the photoreceptor 1Y is charged to a potential of from −600 V to −800 V by the charging roll 2Y.

The photoreceptor 1Y is formed by laminating a photosensitive layer on a conductive substrate (for example, volume resistivity at 20° C.: 1×10⁻⁶ Ωcm or less). The photosensitive layer typically has high resistance (the resistance of a general resin), but has properties in which when laser beams 3Y are applied, the specific resistance of a portion that is irradiated with the laser beams changes. Accordingly, the laser beams 3Y are output to the charged surface of the photoreceptor 1Y via the exposure device 3 in accordance with image data for yellow sent from the controller (not shown). The laser beams 3Y are applied to the photosensitive layer on the surface of the photoreceptor 1Y, whereby an electrostatic charge image of a yellow image pattern is formed on the surface of the photoreceptor 1Y.

The electrostatic charge image is an image that is formed on the surface of the photoreceptor 1Y by charging, and is a so-called negative latent image, that is formed by applying the laser beams 3Y to the photosensitive layer so that the specific resistance of the irradiated portion is lowered to cause charges to flow on the surface of the photoreceptor 1Y, while charges stay on a portion to which the laser beams 3Y are not applied.

The electrostatic charge image that is formed on the photoreceptor 1Y is rotated up to a predetermined developing position with the travelling of the photoreceptor 1Y. The electrostatic charge image on the photoreceptor 1Y is visualized (developed) as a toner image at the developing position by the developing device 4Y.

The developing device 4Y accommodates, for example, an electrostatic charge image developer including at least a yellow toner and a carrier. The yellow toner is frictionally charged by being stirred in the developing device 4Y to have a charge with the same polarity (negative polarity) as the electrostatic charge that is charged on the photoreceptor 1Y, and is thus held on the developer roll (an example of the developer holding member). By allowing the surface of the photoreceptor 1Y to pass through the developing device 4Y, the yellow toner electrostatically adheres to an erased latent image portion on the surface of the photoreceptor 1Y, and the latent image is developed with the yellow toner. Next, the photoreceptor 1Y having the yellow toner image formed thereon travels at a predetermined rate and the toner image developed on the photoreceptor 1Y is transported to a predetermined primary transfer position.

When the yellow toner image on the photoreceptor 1Y is transported to the primary transfer position, a primary transfer bias is applied to the primary transfer roll 5Y, an electrostatic force toward the primary transfer roll 5Y from the photoreceptor 1Y acts on the toner image, and the toner image on the photoreceptor 1Y is transferred onto the intermediate transfer belt 20. The transfer bias applied at this time has the polarity (+) opposite to the toner polarity (−), and is controlled to, for example, +10 μA in the first unit 10Y by the controller (not shown).

On the other hand, the toner remaining on the photoreceptor 1Y is removed and collected by the photoreceptor cleaning device 6Y.

The primary transfer biases that are applied to the primary transfer rolls 5M, 5C, and 5K of the second unit 10M and the subsequent units are also controlled in the same manner as in the case of the first unit.

In this manner, the intermediate transfer belt 20 onto which the yellow toner image is transferred in the first unit 10Y is sequentially transported through the second to fourth units 10M, 100, and 10K, and the toner images of respective colors are multiply-transferred in a superimposed manner.

The intermediate transfer belt 20 onto which the four color toner images have been multiply-transferred through the first to fourth units reaches a secondary transfer portion that includes the intermediate transfer belt 20, the support roll 24 contacting the inner surface of the intermediate transfer belt, and a secondary transfer roll (an example of the secondary transfer unit) 26 arranged on the image holding surface side of the intermediate transfer belt 20. Meanwhile, a recording sheet (an example of the recording medium) P is supplied to a gap between the secondary transfer roll 26 and the intermediate transfer belt 20, that are brought into contact with each other, via a supply mechanism at a predetermined timing, and a secondary transfer bias is applied to the support roll 24. The transfer bias applied at this time has the same polarity (−) as the toner polarity (−), and an electrostatic force toward the recording sheet P from the intermediate transfer belt 20 acts on the toner image, and the toner image on the intermediate transfer belt 20 is transferred onto the recording sheet P. In this case, the secondary transfer bias is determined depending on the resistance detected by a resistance detector (not shown) that detects the resistance of the secondary transfer portion, and is voltage-controlled.

Thereafter, the recording sheet P is fed to a pressure contacting portion (nip portion) between a pair of fixing rolls in a fixing device (an example of the fixing unit) 28 so that the toner image is fixed to the recording sheet P to form a fixed image.

Examples of the recording sheet P onto which a toner image is transferred include plain paper that is used in electrophotographic copiers, printers, and the like, and as a recording medium, an OHP sheet and the like are also exemplified other than the recording sheet P.

The surface of the recording sheet P is preferably smooth in order to further improve smoothness of the image surface after fixing. For example, coating paper obtained by coating a surface of plain paper with a resin or the like, art paper for printing, and the like are suitably used.

The recording sheet P on which the fixing of the color image is completed is discharged toward a discharge portion, and a series of the color image forming operations ends.

Process Cartridge and Toner Cartridge

A process cartridge according to this exemplary embodiment will be described.

The process cartridge according to this exemplary embodiment includes a developing unit that accommodates the electrostatic charge image developer according to this exemplary embodiment and develops an electrostatic charge image formed on a surface of an image holding member with the electrostatic charge image developer to form a toner image, and is detachable from an image forming apparatus.

The process cartridge according to this exemplary embodiment is not limited to the above-described configuration, and may be configured to include a developing device, and if necessary, at least one selected from other units such as an image holding member, a charging unit, an electrostatic charge image forming unit, and a transfer unit.

Hereinafter, an example of the process cartridge according to this exemplary embodiment will be shown. However, the process cartridge is not limited thereto. Main portions shown in the drawing will be described, but descriptions of other parts will be omitted.

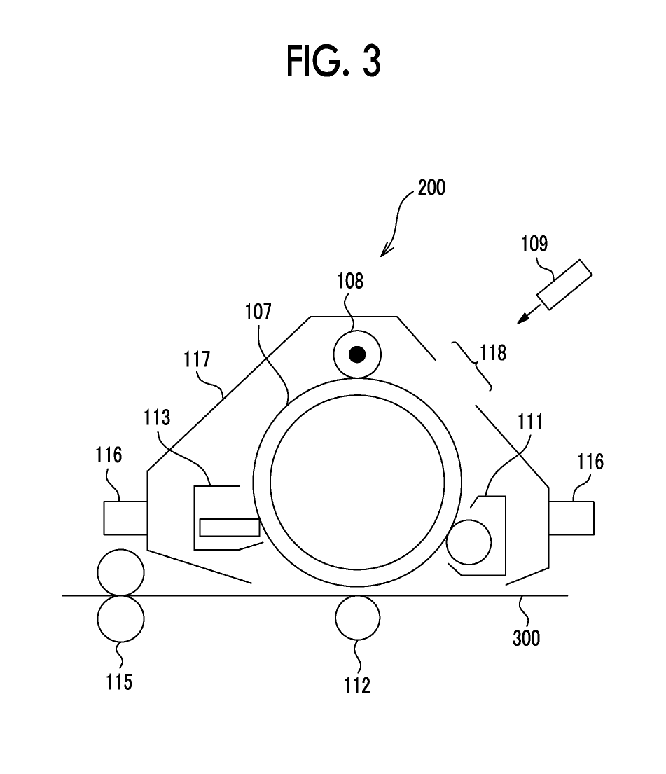

FIG. 3 is a schematic diagram showing the configuration of the process cartridge according to this exemplary embodiment.

A process cartridge 200 shown in FIG. 3 is formed as a cartridge having a configuration in which a photoreceptor 107 (an example of the image holding member), a charging roll 108 (an example of the charging unit) provided around the photoreceptor 107, a developing device 111 (an example of the developing unit), and a photoreceptor cleaning device 113 (an example of the cleaning unit) are integrally combined and held by, for example, a casing 117 provided with a mounting rail 116 and an opening 118 for exposure.

In FIG. 3, the reference numeral 109 represents an exposure device (an example of the electrostatic charge image forming unit), the reference numeral 112 represents a transfer device (an example of the transfer unit), the reference numeral 115 represents a fixing device (an example of the fixing unit), and the reference numeral 300 represents a recording sheet (an example of the recording medium).

Next, a toner cartridge according to this exemplary embodiment will be described.

The toner cartridge according to this exemplary embodiment is a toner cartridge that accommodates the toner according to this exemplary embodiment and is detachable from an image forming apparatus. The toner cartridge accommodates a toner for replenishment for being supplied to the developing unit provided in the image forming apparatus.

The image forming apparatus shown in FIG. 2 has a configuration in which the toner cartridges 8Y, 8M, 8C, and 8K are detachable therefrom, and the developing devices 4Y, 4M, 4C, and 4K are connected to the toner cartridges corresponding to the respective developing devices (colors) with toner supply tubes (not shown), respectively. In addition, when the toner accommodated in the toner cartridge runs low, the toner cartridge is replaced.

### EXAMPLES

Hereinafter, this exemplary embodiment will be described more specifically using Examples and Comparative Examples, but is not limited to these examples. Unless specifically noted, the terms “parts” and “%” means “parts by weight” and “% by weight”.

Preparation of Polyester Resin

Preparation of Polyester Resin (A1)
Polycarboxylic acid

Terephthalic acid: 90 parts by mol Sodium 5-isophthalic acid sulfonate: 1 part by mol
Polyol

Ethylene glycol: 50 parts by mol

1,5-pentanediol: 50 parts by mol
Epoxy compound

Polyepoxy compound: 9 parts by mol

(EPICLON N-695, manufactured by DIC Corporation)

3 parts by weight of the total of the polycarboxylic acid component and the polyol component is put into a 5 liter flask equipped with a stirring device, a nitrogen inlet tube, a temperature sensor, and a rectifier, heated to a temperature of 190° C. for 1 hour and stirred in a reaction system. Then, a catalyst Ti(OBu)₄ (0.003% by weight with respect to the total amount of the polycarboxylic acid component) is charged thereinto.

Further, the temperature is slowly raised from the above temperature to 245° C. while distilling water generated, and a dehydration condensation reaction continues for 6 hours for polycondensation reaction. Then, the temperature is lowered to 235° C. and the reaction is conducted for 2 hours under a reduced pressure of 30 mmHg. Thus, Polyester resin (A1) is obtained. When the resin molecular weight of Polyester resin (A1) thus obtained is measured by gel permeation chromatography (GPC), the weight average molecular weight is 80,000. In addition, as a result of measuring the heat properties of the resin obtained by a differential scanning calorimeter, Tg (secondary transition temperature) is 61° C. Further, the softening temperature of the obtained resin (flow tester (½) effluent temperature, Tm) is measured using an elevated flow tester (CFT-500) (manufactured by SHIMADZU CORPORATION) under conditions of a dice having a pore diameter of 1 mm, an applied pressure of 10 kg/cm², and a temperature raising rate of 3° C./minute, as a temperature corresponding to ½ of the height from a flow start point when a sample of 1 cm³ is melted and flowed out to an end point. As a result, Tm is 145° C.

Preparation of Polyester resins (A2) to (A7) and (C1)

Polyester resins (A2) to (A7) and (C1) are prepared in the same manner as in the preparation of Polyester resin (A1) except that the kind and amount of polycarboxylic acid component, the kind and amount of polyol component, the amount of epoxy compound, and reaction conditions are changed according to Table 1. In the preparation of Polyester resin (A6), a reaction is conducted without reducing the pressure.

In addition, the physical properties of the obtained polyester resins are shown in Table 2.

TABLE 1

| | | | Polyester resin | | | | | | | |
|---|---|---|---|---|---|---|---|---|---|---|
| | | | A1 | A2 | A3 | A4 | A5 | A6 | A7 | C1 |
| polycarboxylic | Part by mol | Terephthalic acid | 90 | 92 | 87 | 93 | 98.5 | 99 | 90 | 90 |
| acid | | 5-isophthalic acid | 1 | 1 | 1 | 1 | 1 | 1 | 1 | 1 |
| | | sulfonate Na | | | | | | | | |
| Polyol | Part by mol | Ethylene glycol | 50 | 50 | 50 | 50 | 50 | 50 | 50 | — |
| | | 1,5-pentanediol | 50 | 50 | 50 | 50 | 50 | 50 | — | — |
| | | 1,12-dodecanediol | — | — | — | — | — | — | 50 | — |
| | | EO 2 mole adduct of | — | — | — | — | — | — | — | 34 |
| | | BPA | | | | | | | | |
| | | PO 2 mole adduct of | — | — | — | — | — | — | — | 66 |
| | | BPA | | | | | | | | |
| Epoxy | Part by mol | Polyepoxy compound | 9 | 7 | 12 | 6 | 0.5 | — | 9 | 9 |
| compound | | | | | | | | | | |
| Reaction | Reaction | Temperature (° C.) | 245 | 245 | 245 | 245 | 245 | 245 | 245 | 245 |
| condition | | Time (Hr) | 6 | 6 | 6 | 6 | 6 | 6 | 6 | 6 |
| | Reaction | Temperature (° C.) | 235 | 235 | 235 | 235 | 235 | 235 | 235 | 235 |
| | under | Reduced pressure | 30 | 30 | 30 | 30 | 60 | Not | 30 | 30 |
| | reduced | (mmHg) | | | | | | applicable | | |
| | pressure | Time (Hr) | 2 | 2 | 2 | 1 | 1 | 2 | 2 | 2 |

In Table 1, the “EC 2 mole adduct of BPA” represents an adduct of 2 mol of ethylene oxide to bisphenol A.

The “PO 2 mole adduct of BPA” represents an adduct of 2 mol of propylene oxide to bisphenol A.

The “5-isophthalic acid sulfonate Na” represents sodium 5-isophthalic acid sulfonate.

The “polyepoxy compound” represents EPICLON N-695 (cresol novolac type polyfunctional epoxy) manufactured by DIC Corporation.

TABLE 2

| | Polyester resin | | | | | | | |
|---|---|---|---|---|---|---|---|---|
| | A1 | A2 | A3 | A4 | A5 | A6 | A7 | C1 |
| Number average | 6,000 | 5,800 | 6,000 | 6,300 | 6,000 | 8,000 | 6,000 | 5,500 |
| molecular | | | | | | | | |
| weight (Mn) | | | | | | | | |
| Weight average | 80,000 | 75,000 | 70,000 | 100,000 | 20,000 | 90,000 | 85,000 | 80,000 |
| molecular | | | | | | | | |
| weight (Mw) | | | | | | | | |
| Glass transition | 61 | 61 | 61 | 62 | 63 | 62 | 61 | 61 |
| temperature Tg | | | | | | | | |
| (° C.) | | | | | | | | |
| Tm (° C.) | 145 | 144 | 144 | 146 | 148 | 145 | 145 | 148 |
| THF insoluble | 20 | 10 | 25 | 13 | 2 | 0 | 20 | 19 |
| gel content (%) | | | | | | | | |

### Example 1

### Preparation of Toner

Preparation of Toner Particle (1)
Polyester resin (A1): 87 parts
Paraffin wax (HNP-9 manufactured by Nippon Seiro Co., Ltd.): 5 parts
Carbon black (Regal 330 manufactured by Cabot Corporation): 7 parts
Charge controlling agent (Bontron P-51 manufactured by Orient Chemical Corp.): 1 part

The above components are mixed with a 75 L Henschel Mixer, followed by kneading by using a biaxial continuous kneader having the screw configuration under kneading conditions of a kneading rate of 15 kg/h and a kneading temperature of 120° C. Thus, a kneaded material is obtained. This kneaded material is pulverized using an IDS-2 collision plate type pulverizer (manufactured by Nippon Pneumatic Mfg. Co., Ltd.) and then classified by adjusting and changing the classification edge using a pneumatic type Elbow-jet classifier (manufactured by Matsubo Corporation) to remove fine and coarse powder. Thus, Toner particle (1) is obtained.

Preparation of Toner (1)

100 parts of Toner particles (1) obtained and 1 part of silica particles (R972, manufactured by Nippon Aerosil Co., Ltd., volume average particle diameter: 16 nm) are mixed with a sample mill at 6,000 rpm for 60 seconds. The mixture is mixed with a Henschel Mixer at a circumferential rate of 20 m/s for 15 minutes and then coarse particles are removed by a sieve having a mesh size of 45 μm. Thus, Toner (1) is obtained.

### Examples 2 to 11 and Comparative Examples 1 to 3

Toners (2) to (9) of Examples 2 to 4, Examples 8 to 10, and Comparative Examples 1 and 2 are obtained in the same manner as in Example 1 except that the kind of polyester resin and kneading conditions are changed according to Table 3. In addition, Toners (10) to (15) of Examples 5 to 7 and 11, and Comparative Examples 3 and 4 are obtained in the same manner as in Example 1 except that the classification edge is changed. The ratio Mw (A)/Mn (A) of the low molecular weight region (A) of the toner particles obtained in each example, the particle diameter, and the tetrahydrofuran insoluble component (THF insoluble component) are measured by the aforementioned methods.

TABLE 3

| | | | | | | | | | THF | | | |
|---|---|---|---|---|---|---|---|---|---|---|---|---|
| | | | | | | | | | insoluble | | | |
| | | | | Kneading condition | | | | | component | | | |
| | Toner | PES | BPA | Rate | Temperature | | | Mw (A)/ | (% by | Tg | Low | D50v |
| | No. | No. | derivative | (kg/h) | (° C.) | Mn (A) | Mw (A) | Mn (A) | weight) | (° C.) | GSDp | (μm) |
| Example 1 | Toner 1 | A1 | Absence | 15 | 120 | 5,000 | 18,000 | 3.6 | 7 | 60 | 1.41 | 8 |
| Example 2 | Toner 2 | A1 | Absence | 10 | 100 | 4,500 | 22,000 | 4.9 | 6.5 | 60 | 1.51 | 8 |
| Example 3 | Toner 3 | A2 | Absence | 15 | 120 | 4,500 | 25,000 | 5.6 | 3 | 60 | 1.37 | 8 |
| Example 4 | Toner 4 | A3 | Absence | 10 | 160 | 4,800 | 16,000 | 3.3 | 10 | 60 | 1.40 | 8 |
| Example 8 | Toner 5 | A3 | Absence | 18 | 120 | 4,500 | 18,000 | 4 | 12 | 60 | 1.39 | 8 |
| Comparative | Toner 6 | A4 | Absence | 15 | 120 | 5,000 | 40,000 | 8 | 6 | 62 | 1.32 | 8 |
| Example 1 | | | | | | | | | | | | |
| Example 9 | Toner 7 | A5 | Absence | 15 | 120 | 3,500 | 11,000 | 3.1 | 1.5 | 61 | 1.42 | 8 |
| Example 10 | Toner 8 | A6 | Absence | 15 | 120 | 6,700 | 40,000 | 6 | 0 | 61 | 1.35 | 8 |
| Comparative | Toner 9 | C1 | Presence | 15 | 120 | 4,800 | 19,000 | 4 | 7 | 61 | 1.32 | 8 |
| Example 2 | | | | | | | | | | | | |
| Comparative | Toner 10 | A1 | Absence | 15 | 120 | 5,000 | 18,000 | 3.6 | 7 | 60 | 1.20 | 8 |
| Example 3 | | | | | | | | | | | | |
| Example 5 | Toner 11 | A1 | Absence | 15 | 120 | 5,000 | 18,000 | 3.6 | 7 | 60 | 1.30 | 8 |
| Example 6 | Toner 12 | A1 | Absence | 15 | 120 | 5,000 | 18,000 | 3.6 | 7 | 60 | 1.50 | 8 |
| Example 7 | Toner 13 | A1 | Absence | 15 | 120 | 5,000 | 18,000 | 3.6 | 7 | 60 | 1.70 | 8 |
| Comparative | Toner 14 | A1 | Absence | 15 | 120 | 5,000 | 18,000 | 3.6 | 7 | 60 | 1.80 | 8 |
| Example 4 | | | | | | | | | | | | |
| Example 11 | Toner 15 | A7 | Absence | 15 | 120 | 5,000 | 19,000 | 3.8 | 7 | 60 | 1.41 | 8 |

In Table 3, the “PES” represents polyester, the “BPA” represents bisphenol A, and the “THF” represents tetrahydrofuran, respectively.

In addition, the “low GSDp” represents a small diameter side number average particle diameter index and the “D50v” represents a volume average particle diameter, respectively.

Preparation of Magnetic Particle Containing Carrier

(1) Formation of Core

A core is formed by the following manner.

Into a Henschel mixer is put 500 parts of a spherical magnetite particle powder having a volume average particle diameter of 0.50 μm, and the materials are stirred. Then, 5.0 parts of a titanate coupling agent is added, the temperature is raised to 100° C., and the materials are mixed and stirred for 30 minutes. Thus, spherical magnetite particles coated with the titanate coupling agent are obtained. Subsequently, 6.25 parts of phenol, 9.25 parts of 35% formalin, 500 parts of the spherical magnetite particle obtained above, 6.25 parts of 25% ammonia aqueous solution, and 425 parts of water are put into a 1 L four-neck flask, and the materials are mixed and stirred. Next, while stirring, a temperature is raised to 85° C. for 60 minutes, followed by allowing the mixture to undergo a reaction at the same temperature for 120 minutes. Thereafter, the reaction solution is cooled to 25° C., 500 ml of water is added thereto, the supernatant is removed, and the precipitate is washed with water. Under reduced pressure, the precipitate is dried at a temperature from 150° C. to 180° C. to obtain core particles having a volume average particle diameter of 30 μm.

(2) Formation of Resin Layer (Formation of Recessed Portion)

A resin layer having a recessed portion on the surface of the core is formed by the following manner.

12 parts of a polytetrafluoroethylene resin powder and 0.86 parts of a silicon dioxide powder (average particle diameter: 120 nm) obtained by surface-treating a polymethyl methacrylate resin are put into a V blender and mixed and stirred for 20 minutes. 400 parts of the obtained powder mixture and core particles are put into a dry type combined treatment apparatus NOBILTA NOB130 (manufactured by Hosokawa Micron Corporation) and treated for 30 minutes at 1,000 rpm. The obtained powder and 1,000 parts of acetone are put into a 2 L container with a stirring blade and stirred at 150 rpm for 30 minutes. Then, solid-liquid separation is performed using a filer paper having an opening of 10 μm. The filtered material is dissolved in 1,000 parts of acetone again and stirred at 150 rpm for 30 minutes. Then, solid-liquid separation is performed again using a filer paper having an opening of 10 μm. Next, vacuum drying is performed for 2 hours and the dried material is allowed to pass through a mesh having an opening of 75 μm. Thus, a carrier having a volume average particle diameter of 35 μm is obtained.

Preparation of Developer

The carrier and Toner (1) are put into a V blender at a weight ratio of 95:5 and stirred for 20 minutes. Thus Developer (1) is obtained. In addition, Developers (2) to (15) are obtained by changing the Toner (1) to toners obtained in each example.

Evaluation

Evaluation of Low Temperature Offset

A modified machine of an image forming apparatus “DocuCentre Color 500” (manufactured by Fuji Xerox Co., Ltd, fixing temperature: 120° C., image forming rate: 350 mm/sec) adopting a two-component contact developing type is used, each developer is put into the developing unit of this image forming apparatus, and the developer is allowed to stand for 5 hours in an environment of a temperature of 10° C. Then, 20 sheets of images having an image density of 100% with a width of 20 mm in a feeding direction of a recoding sheet (Colotech+90 g sm, manufactured by Fuji Xerox Co., Ltd) are output and evaluation is performed based on the following criteria.

Evaluation of Low Temperature Offset

A: No image defect at all

B: No problem

C: Slight image defect, but at an unproblematic level

D: Image defect is formed and it is determined to be NG

Evaluation of High Temperature Offset

A modified machine of an image forming apparatus “DocuCentre Color 500” (manufactured by Fuji Xerox Co., Ltd, fixing temperature: 220° C., image forming rate: 250 mm/sec) adopting a two-component contact developing type is used, each developer is put into the developing unit of this image forming apparatus, and the developer is allowed to stand for 5 hours in an environment of a temperature of 10° C. Then, 20 sheets of images having an image density of 100% with a width of 20 mm in a feeding direction of a recoding sheet (Colotech+90 g sm, manufactured by Fuji Xerox Co., Ltd) are output and evaluation is performed based on the following criteria.

Evaluation of High Temperature Offset

A: No image defect at all

B: No problem

C: Slight image defect, but at an unproblematic level

D: Image defect is formed and it is determined to be NG

TABLE 4

| | | | | | Low | High |
|---|---|---|---|---|---|---|
| | Developer | Toner | PES | BPA | temperature | temperature |
| | No. | No. | No. | derivative | offset | offset |
| Example 1 | Developer 1 | Toner 1 | A1 | Absence | A | A |
| Example 2 | Developer 2 | Toner 2 | A1 | Absence | B | A |
| Example 3 | Developer 3 | Toner 3 | A2 | Absence | B | A |
| Example 4 | Developer 4 | Toner 4 | A3 | Absence | A | A |
| Example 8 | Developer 5 | Toner 5 | A3 | Absence | B | A |
| Comparative | Developer 6 | Toner 6 | A4 | Absence | D | B |
| Example 1 | | | | | | |
| Example 9 | Developer 7 | Toner 7 | A5 | Absence | B | C |
| Example 10 | Developer 8 | Toner 8 | A6 | Absence | C | C |
| Comparative | Developer 9 | Toner 9 | C1 | Presence | D | B |
| Example 2 | | | | | | |
| Comparative | Developer 10 | Toner 10 | A1 | Absence | D | B |
| Example 3 | | | | | | |
| Example 5 | Developer 11 | Toner 11 | A1 | Absence | B | B |
| Example 6 | Developer 12 | Toner 12 | A1 | Absence | A | A |
| Example 7 | Developer 13 | Toner 13 | A1 | Absence | B | B |
| Comparative | Developer 14 | Toner 14 | A1 | Absence | D | C |
| Example 4 | | | | | | |
| Example 11 | Developer 15 | Toner 15 | A7 | Absence | A | A |

From the above results, it is found that in Examples, the evaluation of “low temperature offset” is excellent compared to Comparative Examples.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

1. An electrostatic charge image developing toner comprising:
toner particles containing a polyester resin that is a polycondensate of a polycarboxylic acid and a polyol not containing a derivative of bisphenol A,
wherein, when a maximum value is present on a lowest molecular weight side in a molecular weight distribution curve obtained by subjecting a component soluble in tetrahydrofuran in the toner particles to a gel permeation chromatography measurement, a weight average molecular weight (Mw (A)) and a number average molecular weight thereof (Mn (A)), each with respect to a low molecular weight region (A) including the maximum value on the lowest molecular weight side, satisfy that a ratio Mw (A)/Mn (A) is 6.0 or less,
a small diameter side number average particle diameter distribution index of the toner particles is from 1.3 to 1.7,
the polyol is at least one selected from the group consisting of ethylene glycol, 1,5-pentanediol, and 1,12-dodecanediol, and
the polycarboxylic acid includes an aromatic polycarboxylic acid.

2. The electrostatic charge image developing toner according to claim 1,
wherein the component insoluble in tetrahydrofuran of the toner particles is in an amount of from 3% by weight to 10% by weight with respect to the toner particles.

3. The electrostatic charge image developing toner according to claim 1,
wherein the volume average particle diameter of the toner particles is from 5 μm to 14 μm.

4. (canceled)

5. (canceled)

6. The electrostatic charge image developing toner according to claim 1,
wherein the glass transition temperature of the polyester resin is from 50° C. to 80° C.

7. The electrostatic charge image developing toner according to claim 1, further comprising:
a release agent having a melting temperature of from 50° C. to 110° C.

8. The electrostatic charge image developing toner according to claim 1,
wherein the ratio Mw (A)/Mn (A) is from 2 to 5.

9. The electrostatic charge image developing toner according to claim 1,
wherein the small diameter side number average particle diameter distribution index is from 1.35 to 1.5.

10. An electrostatic charge image developer comprising:
the electrostatic charge image developing toner according to claim 1.

11. A toner cartridge that accommodates the electrostatic charge image developing toner according to claim 1 and is detachable from an image forming apparatus.

12. The electrostatic charge image developing toner according to claim 1, wherein the polyol includes ethylene glycol, 1,5-pentanediol, and 1,12-dodecanediol, and the polycarboxylic acid includes an aromatic polycarboxylic acid.
